(19) United States
(12) Patent Application Publication
(10) Pub. No.: US 2018/0124351 A1
(43) Pub. Date: May 3, 2018

(54) SYSTEMS AND METHODS FOR CONSERVING COMPUTING RESOURCES DURING AN ONLINE OR VIRTUAL SHOPPING SESSION

(71) Applicant: Wal-Mart Stores, Inc., Bentonville, AR (US)

(72) Inventors: Todd D. Mattingly, Bentonville, AR (US); Donald R. High, Noel, MO (US); David Tovey, Rogers, AR (US); Nicholas Ray Antel, Springdale, AR (US); John J. O'Brien, Farmington, AR (US)

(21) Appl. No.: 15/793,483

(22) Filed: Oct. 25, 2017

Related U.S. Application Data
(60) Provisional application No. 62/413,648, filed on Oct. 27, 2016.

(51) Int. Cl. H04N 5/63; H04N 5/222; G06F 1/32; G09G 5/02; G06Q 30/06

(52) U.S. Cl. CPC H04N 5/63; H04N 5/2224; G09G 2320/06; G09G 5/02; G06Q 30/0643; G06F 1/3203

(57) ABSTRACT

In some embodiments, apparatuses and methods are provided herein useful for providing an online shopping experience that conserves computing resources. In some embodiments, there is provided a system including: a shopping server configured to receive a user request to view a virtual shopping environment of virtual shopping images with virtual objects; and a control circuit configured to: cause the display of virtual shopping images on a user computer in an interactive simulation view to emulate a real-life shopping experience for the user; determine a real time computing resource usage of the online shopping session at different times during the online shopping session; and cause the display of at least one of the virtual objects at a first, reduced resource consumption setting when the resource usage exceeds a certain limit and at a second, higher resource consumption setting when the resource usage does not exceed the limit.

### CROSS-REFERENCE TO RELATED APPLICATION

This application claims the benefit of U.S. Provisional Application No. 62/413,648, filed Oct. 27, 2016, which is incorporated by reference in its entirety herein.

### TECHNICAL FIELD

This invention relates generally to providing an online shopping experience that conserves computing resources, and more particularly, to providing an online shopping experience that conserves computing resources by adjusting the display quality of virtual objects.

### BACKGROUND

In the retail setting, one area that is becoming of increasing significance is the virtual shopping environment. Some retailers have established an online shopping experience for customers in which the customer may participate in a realistic shopping experience without actually going to a store. Instead, the customer may access the retailer's website and navigate through a realistic appearing store that may have various departments and various types of products for sale.

In this virtual shopping environment, the computing resources of the environment must be carefully managed. Customers will become dissatisfied if the virtual shopping environment responds sluggishly to user inputs or fails entirely. Accordingly, it is desirable to develop approaches that conserve computing resources during the online shopping experience.

### BRIEF DESCRIPTION OF THE DRAWINGS

Disclosed herein are embodiments of systems, apparatuses and methods pertaining to providing an online shopping experience that conserves computing resources. This description includes drawings, wherein:

FIG. 1 is a screenshot of an online shopping session in accordance with some embodiments;

FIG. 2 is a block diagram in accordance with some embodiments;

FIG. 3 is a screenshot of an online shopping session in accordance with some embodiments;

FIG. 4 is a screenshot of an online shopping session in accordance with some embodiments;

FIG. 5 is a screenshot of an online shopping session in accordance with some embodiments

FIG. 6 is a block diagram in accordance with some embodiments;

FIG. 7 is a flow diagram in accordance with some embodiments;

FIG. 8 is a block diagram in accordance with some embodiments; and

FIG. 9 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to providing an online shopping experience that conserves computing resources. In some embodiments, there is provided a system including: a shopping server configured to receive a user request to view a virtual shopping environment comprising a plurality of virtual shopping images, each image including one or more virtual objects; and a control circuit configured to: cause the display of at least one of the plurality of virtual shopping images on a user computer in an interactive simulation view to emulate a real-life shopping experience for the user, the virtual shopping images being transmitted from the shopping server to the user computer during an online shopping session; determine a real time computing resource usage of the online shopping session at different times during the online shopping session; adjust a quality of the display of the virtual shopping environment; cause the display of at least one of the virtual objects at a first, reduced resource consumption setting to conserve computing resources in response to a determination that the resource usage exceeds a predetermined limit; and cause the display of the at least one virtual object at a second, higher resource consumption setting in response to a determination that the resource usage does not exceed the predetermined limit.

In one form, in the system, the control circuit may be configured to adjust the display of the at least one virtual object between a low resolution corresponding to the first, reduced resource consumption setting and a high resolution corresponding to the second, higher resource consumption setting. Further, the control circuit may be configured to adjust the resolution of the at least one virtual object along a range of values between a low resolution limit and a high resolution limit in response to each determination of real time computing resource usage during the online shopping session. In addition, in the system, the at least one virtual object may include an avatar representing the user in the virtual shopping session; and the control circuit may be configured to adjust the display of the avatar or a portion of the avatar between a low resolution and a high resolution. Also, in the system, the at least one virtual object may represent the surroundings near an avatar that represents the user in the virtual shopping session; and the control circuit may be configured to adjust the display of the surroundings or a portion of the environment between a low resolution and a high resolution.

In one form, in the system, the control circuit may be configured to scale the display of the at least one virtual object between a first size corresponding to the first, reduced resource consumption setting and a second size corresponding to the second, higher resource consumption setting. Further, the user computer may include a desktop computer, laptop computer, tablet computer, or mobile computing device.

In one form, in the system, the control circuit may be configured to: determine the real time computing resource usage of the online shopping session at predetermined time intervals; and determine whether to adjust the quality of the display of the virtual shopping environment at each of these predetermined time intervals. In addition, the control circuit may be configured to: determine the real time computing resource usage of the online shopping session at predetermined virtual shopping locations in the virtual shopping environment; and determine whether to adjust the quality of the display of the virtual shopping environment at each of these predetermined virtual shopping locations. Also, the control circuit may be configured to determine the real time computing resource usage of at least one of the shopping server and the user computer. Moreover, in the system, the shopping server may be configured to transmit a 3D virtual reality shopping environment to the user computer through a virtual reality interface.

In another form, there is provided a method for providing an online shopping experience that conserves computing resources, the method including: by a shopping server, receiving a user request to view a virtual shopping environment comprising a plurality of virtual shopping images, each image including one or more virtual objects; and by a control circuit: causing to display at least one of the plurality of virtual shopping images on a user computer in an interactive simulation view to emulate a real-life shopping experience for the user, the virtual shopping images being transmitted from the shopping server to the user computer during an online shopping session; determining a real time computing resource usage of the online shopping session at different times during the online shopping session; adjusting a quality of the display of the virtual shopping environment; causing to display at least one of the virtual objects at a first, reduced resource consumption setting to conserve computing resources in response to a determination that the resource usage exceed a predetermined limit; and causing to display the at least one virtual object at a second, higher resource consumption setting in response to a determination that the resource usage does not exceed the predetermined limit.

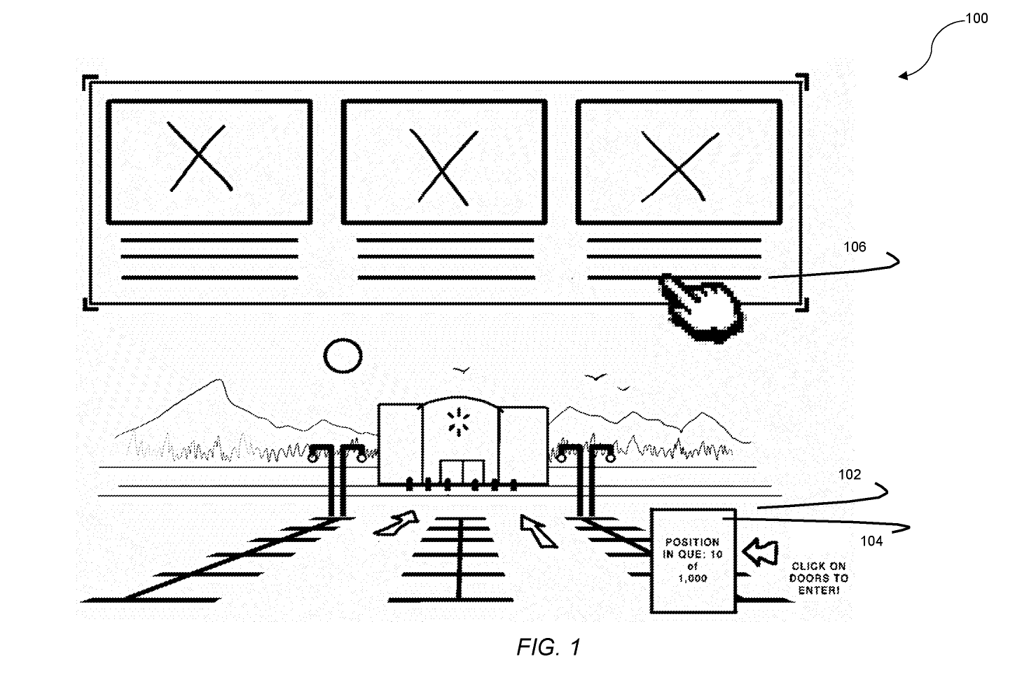

FIGS. 1-5 show one form of an online or virtual shopping experience. In this form, the customer/user may initially access a retailer (or other) website or software application to enter the online or virtual shopping environment. (The terms “customer” and “user” are generally used interchangeably herein.) It is contemplated that the customer may be given the option of various stores of the retailer, and the customer may then select a specific store for shopping. In one form, this option may involve the display of images of stores owned and/or operated by the retailer, and the user can then select one of the stores (such as by a cursor). It is generally contemplated that a customer may be able to login or logout of the customer's account from this initial portal. After choosing a store within this layout, the customer may then be directed to the store's online or virtual location, where the customer may be entered into a queue system, or may enter directly. In general, the terms “online” and “virtual” are used interchangeably herein to refer broadly to a realistic shopping experience without physically going to a store. In contrast, the term “virtual reality” refers generally to a 3D environment that is simulated through a virtual reality interface and other components.

Generally, as an overview, with the implementation of online environments being employed for shopping experiences, there is a concern that computer, server, and graphics rendering power demands may become too overwhelming. Such overwhelming power demands may crash or inhibit the stability of the system itself. Overall, one focus herein is making an online or virtual reality shopping experience viable without demanding too much of computer processing units, graphics processing units, and servers.

Referring to FIG. 1, in one form, there is shown a queue display screen 100 where the customer has entered the retailer's online or virtual shopping experience. In high-traffic situations, the customer may await entry into the online or virtual shopping experience at an online or virtual “parking lot,” where the customer's position in the queue is noted. As can be seen, in this form, the screen 100 may display an image of a retailer parking lot 102 and a wait sign 104 that may indicate the number of customers in the queue (and/or that may show an estimated wait time for entry). This “parking lot” allows for the controlled entry of customer into the online or virtual shopping experience so as to manage the number of customers and the demand on computing resources. This controlled entry seeks to prevent the sluggish response and possible disruption of the system.

This queue display screen 100 may also include a menu and/or banner portion 106 above the image of the parking lot 102. For example, this menu portion 106 may be used to display the following: a welcome back message; sales, special events, and/or reviews; user connections online (friends and family); messages from user connections or from the retailer; the status of delivery of items already ordered; a review section for previously purchased products; and/or account management features (such as login/logout, update account information, change payment method, delivery method, etc.). When the server is ready for the customer to enter into the shopping experience (the user has reached the front of the queue), the customer can then enter, and an online or virtual assistant may then assist the customer in navigating the retail environment (as described below).

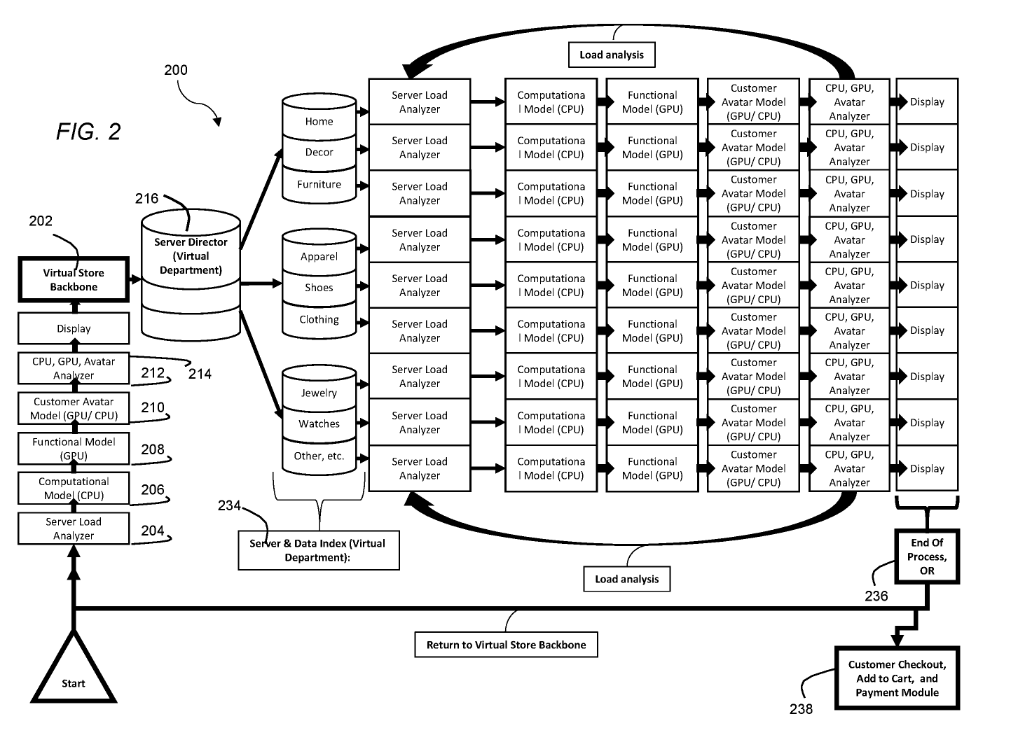

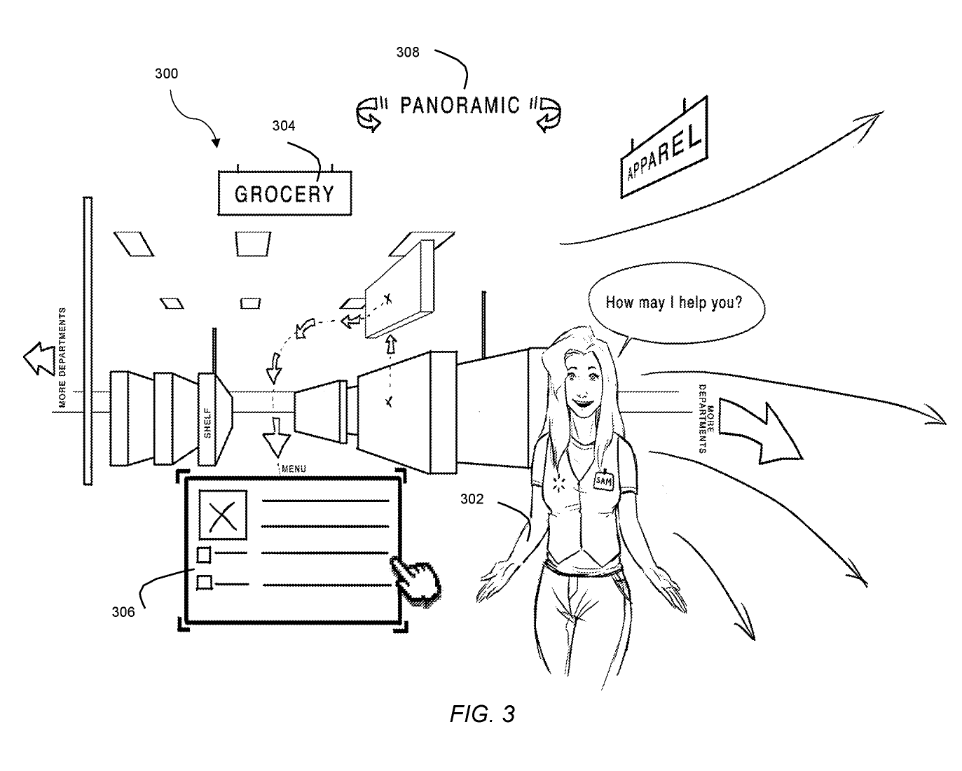

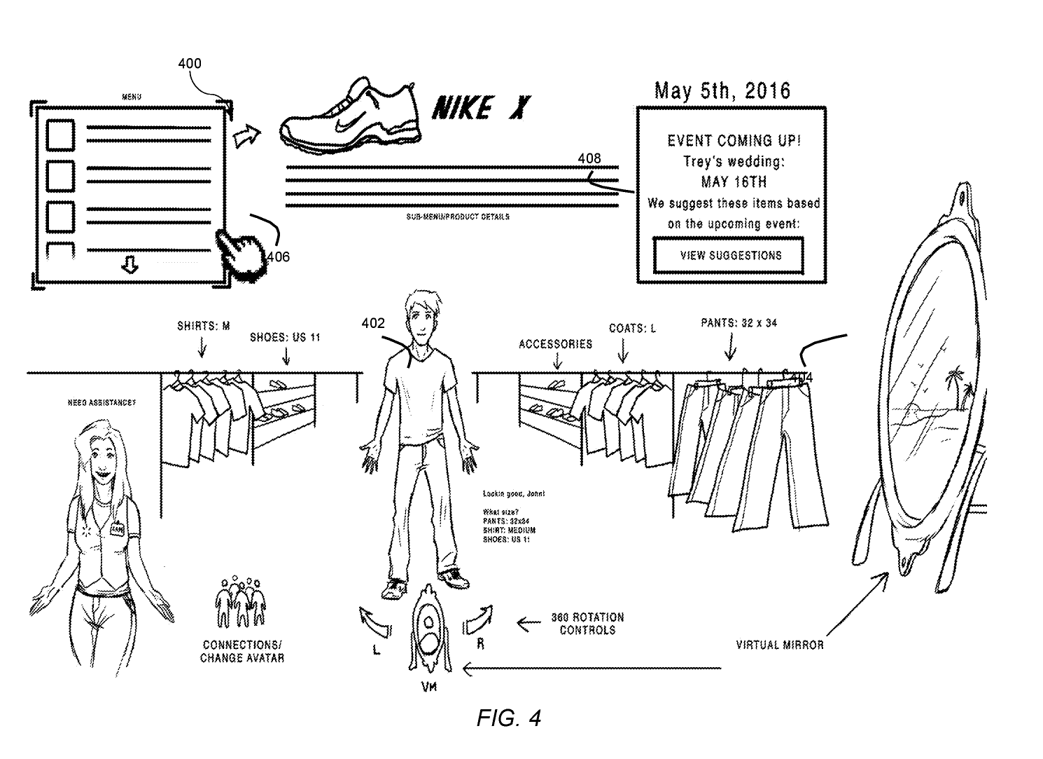

FIG. 2 shows a component model and process diagram 200 showing one example of a general system and workflow overview of the load analysis to try to prevent overload demands. In one form, an online or “virtual store backbone” 202 (also shown generally in one form in FIG. 3) allows the user to navigate through the online or virtual shopping environment to desired store departments. In essence, the virtual store backbone corresponds to general shopping areas, not specific store departments. In one form, the online or virtual store backbone 202 may include the following aspects and components: a server load analyzer 204; a computational model 206; a functional model 208; customer avatar model 210; and CPU/GPU/avatar analyzer 212. The online or virtual store backbone 202 may communicate with a display 214 of the user/customer. A server director 216 may allow selection of and navigation to a specific store department (such as shown in FIG. 4 and addressed below). For example, store departments may include: home, décor, furniture, apparel, shoes, clothing, jewelry, watches, etc. In turn, each store department may include a load analyzer (that may be subdivided into component load analyzers) for determining the computer usage demands by each store department.

In one form, the server load analyzer 204 may determine the load bearing on the server from the server director 216, server and data index 234, and the virtual store backbone 202. The server and data index 234 may include reference points for data and virtual department servers, which may be derived from physical points of location from the server, data, and virtual store backbone 202. In other words, this index 234 may indicate where to find information and where it resides. The server director 216 may split information from the online or virtual store backbone 202 and may send it to the server index (virtual department) 234. After the load bearing on these components has been determined, as well as the load bearing on the specified department(s), the server load analyzer 204 may send information to the computational model (CPU) 206, functional model (GPU) 208, and customer avatar model 210. The load bearing on these components may again be analyzed by the CPU/GPU/avatar analyzer 212, which may, in turn, be shared with the server load analyzer 204.

If the bearing on any of the components is such that the system suffers, the analyzer may set parameters on the components to create a stable online/virtual shopping experience. For instance, if there is a spike in traffic of users entering the online/virtual clothing department, the server load analyzer 204 may analyze this spike in traffic and bottleneck the online/virtual clothing department's components so the environment is stable. So, in this example, if there is a single user in the online/virtual clothing department and the load bearing on the components is not significant, the server load analyzer 204 may analyze this limited traffic and increase the online/virtual clothing department's components so the environment expressed is the highest fidelity available, such as, for example, 4K ultra-high definition.

In one form, it is contemplated that the system may generate a scalable display. Specific data may be gathered from the online or virtual store backbone 202, which may be rendered by computational, functional, and avatar models. The data may be analyzed for load bearing on the CPU, GPU, and server, and the display may then be scaled based on analysis by the server load analyzer. In other words, in a low-load bearing situation, high resolution or definition (such as, for example, 4K ultra-high definition) may be rendered for some or all of the display, while in a high-load bearing situation, a low resolution or definition (such as, for example, standard 720p high definition) may be rendered for some or all of the display.

Other aspects of diagram 200 are briefly described as follows. At the start block 201, a customer may enter the online or virtual store at the online/virtual store backbone 202. The computational model 206 may employ the use of computer processing units for mathematical computations, and different types of computational processors can interface with the functional models 208 and perform mathematical computations. The functional model 208 may employ the use of graphics processing units for rendering graphics, environments, products, etc., and, as indicated, graphics processing units may render graphics at different rates of fidelity depending on the load bearing of the components. The customer avatar model 210 may employ computer processing units and graphics processing units with the customer's inputs either from direct data inputs or from 3D scans of the customer's physical body as a 3D rendered avatar. The CPU, GPU, and avatar analyzer 212 may analyze the entire process stream before the display is rendered for determining if the fidelity should be increased or decreased as it relates to maintaining a stable online/virtual shopping experience. The display 214 is the final rendering of the shopping experience after all components have been used and analyzed for determining an optimal shopping experience while still maintaining its integrity. The end of process 236 may be one of the following: the endpoint of the shopping experience for the customer; the customer's decision and action to leave a specific department and return to the online/virtual store backbone 202; or the customer's decision and action to checkout, to add a purchase cart, and to begin the customer's transaction in the payment module 238. The customer can check out any selected items using the payment module 238 and the customer's preferred method of payment.

When the server is ready for the customer to enter into the shopping experience (such as from FIG. 1), the customer may be directed to a new screen 300. In one form, FIG. 3 shows an image of a screen 300 in which an online or virtual assistant 302 may offer to assist the customer in navigating the retail environment. From this screen, customers are able to select their preferred department or may simply ask the virtual assistant 302 for assistance in finding a product through a search query. As an example, in FIG. 3, the customer has asked for a specified product from the grocery department 304, and a menu 306 has been presented to the user. The menu 306 may feature the product, as well as similar products, specifications for the product, etc. The virtual assistant 302 may provide feedback on customer requests, assistance with navigation, shopping, or product information. Ultimately, this virtual assistant 302 may provide a friendly medium for interaction between the customer and the virtual shopping experience. Further, in one form, the customer's point of view may be changed by way of a panoramic adjuster 308 at the top of the figure, which may allow the customer to see the departments in any manner of his or her choosing.

FIG. 4 shows a screen 400 in which the customer has selected the online/virtual apparel department. It is generally contemplated that the customer may desire a higher resolution or definition when he or she interacts with certain types of products (such as, for example, apparel, shoes, watches, jewelry, cosmetics, etc.). These types of products generally require a more subjective judgment from the customer, so a higher resolution or definition may be desirable. In one form, it is contemplated that the customer may input measurements of the customer or a body scan to show how the customer avatar 402 appears in conjunction with the product.

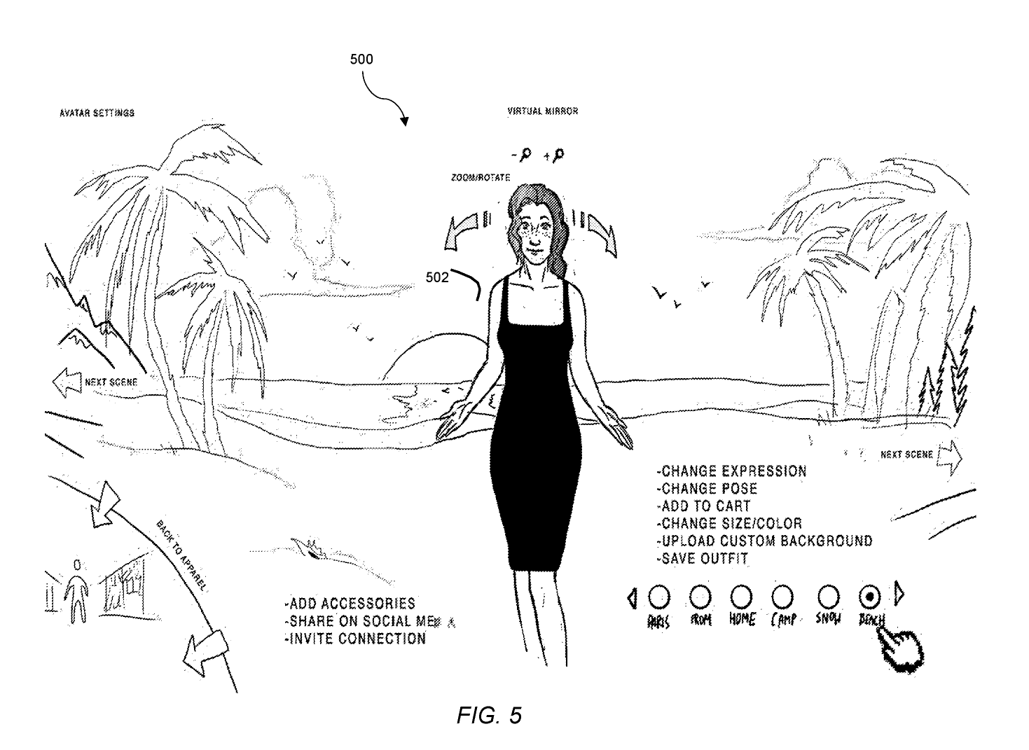

As can be seen in this example, the customer is provided with various apparel options, including shirts, pants, coats, shoes, and accessories. In FIG. 4, the customer has been prompted to input appropriate sizes/dimensions, and the customer may upload his or her own background. Although the assortments of apparel may be specific to the customer, such as shirt size, pant size, coat size, shoe size, etc., the sizing for the apparel may be changed by the customer as well. Apparel alterations can be made by the user, such as size, color, brand, etc. The customer's avatar 402 may then be displayed in conjunction with the selected items via a “virtual mirror” 404 (as described further below with reference to FIG. 5). From this online/virtual dressing room, customers may be able to view apparel in the mirror 404. In one form, fidelity may increase within this online/virtual dressing room (to, for example, 1080p high definition resolution), but the system may employ limited, specific GPU, CPU, server, and other components to avoid overwhelming computer resource demands.

FIG. 4 shows additional options that may be included. For example, the customer may share his or her shopping experience with others via social media. The customer may invite other connections into the virtual shopping room, such as friends and family. In addition, in one form, the user may take a snapshot of the avatar 402 with given clothing, and possibly in a given environment, and then share it with others. For instance, if the customer is trying on a suit for an upcoming wedding, the customer could post images of the avatar 402 wearing the suit so he or she could receive feedback from others. Also, the customer could take a snapshot or some sort of image (or could save the layout) and store it for future viewing or sharing. FIG. 4 shows a menu 406 that may constitute a dynamic display featuring such items as brand, size, reviews, what friends, family, and connections have said about the apparel, etc. FIG. 4 further shows an event calendar 408 that may feature the date as well as the day's activities, and future events, such as a wedding, suggesting items of relevance for the specified occasion.

FIG. 5 shows a screen 500 that may be triggered when the customer uses the online/virtual mirror 404. It is generally contemplated that the avatar 502 can be manipulated to provide more information about interaction with the product, i.e., apparel. It is generally contemplated that the user may be provided with rotation of the avatar 502, zoom-in/zoom-out of the avatar 502, a panoramic 360 degree viewing of the virtual template for the environment displayed within the virtual mirror 404, various poses and expressions, various changes in appearance (including but not limited to hair length, hair color, facial hair, cosmetics, earring, sunglasses, skin tone, etc.) It is further contemplated that the customer may be given the option to add accessories, share the experience on social media, take a screenshot or some sort of image that can be saved for later viewing, and/or invite other connections (such as friends and family) to allow guests to see the clothing worn by the avatar 502 and provide their feedback.

In one form, the customer may be provided with various backgrounds to provide context to the apparel worn by the avatar (or other interaction of the customer with a product). In FIG. 5, in this example, the predefined templates are identified as Paris, prom, camping, snow, and beach but may include other templates. The customer can toggle between different templates and may also upload the customer's own desired background. Fidelity may be increased in this setting (such as, for example, to 4K ultra-high definition resolution), but the system may employ limited, specific GPU, CPU, server, and other components to avoid overuse of computing resources. Users can navigate back to the virtual store, dressing room, or department, by clicking on the “back to apparel” option in the bottom-left quadrant of FIG. 5.

As addressed further herein, in one form, this disclosure seeks to create an environment wherein multiple phases and channels are used with an array of computer processors, graphics processors, and servers to create a stable virtual reality shopping environment that can be rendered at different resolutions throughout the experience. In some forms, where fidelity may need to be expressed with greater definition, such as in an online or virtual reality clothing department, this fidelity may be increased from the original fidelity (such as may be rendered at an online or virtual store mainframe). Alternatively, when the load bearing on a server experiences a spike in user traffic, the overall system may adjust its fidelity and other components to create a stable virtual shopping experience. In some forms, this stability may be achieved through use of a server load analyzer, as well as a CPU, GPU, and avatar analyzer. This server load analyzer may allow for a dynamic scaling of the rendering quality throughout the online or virtual shopping experience, as well as allowing for the intelligent monitoring of the consumption of resources employed by the online or virtual shopping experience.

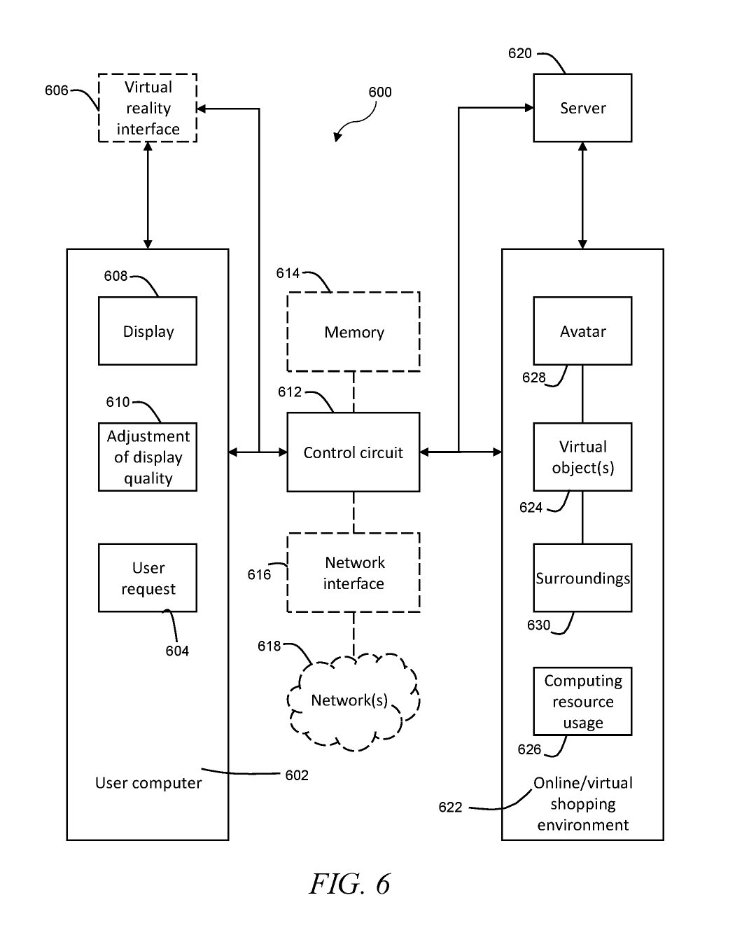

Referring to FIG. 6, there is shown a system 600 for adjusting the display quality of virtual objects during a virtual/online shopping session based on computing power usage. It is generally contemplated that a user will initiate a virtual/online shopping session. As addressed further below, the display quality of certain virtual objects in the virtual/online shopping session may be adjusted, as appropriate, based on the measured computing resource usage of the system 600.

As shown in FIG. 6, the user initiates the session via user computer 602. It is contemplated that any form of user computer 602 may be utilized, including, but not limited to, a desktop computer, laptop computer, tablet computer, or mobile computing device (smartphone, etc.). In one form, the user may initiate the session by accessing a retailer or other website (or software application) and transmitting a user request 604 (such as by clicking on a link on the website) to enter a virtual shopping environment. The shopping session may involve virtual reality (such as through the use of a virtual reality interface 606), but virtual reality is not required. The user computer 602 includes a display 608, and as addressed further below, there is an adjustment of display quality 610 based on computing resource usage of the virtual/online shopping session.

The system 600 also includes a control circuit 612 that is communicatively coupled to the user computer 602 and that generally controls the operation of the system 600. Being a “circuit,” the control circuit 612 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 612 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 612 is configured (for example, by using corresponding programming as will be well understood by those skilled in the art) to carry out one or more of the steps, actions, and/or functions described herein.

By one optional approach, the control circuit 612 operably couples to a memory 614. This memory 614 may be integral to the control circuit 612 or can be physically discrete (in whole or in part) from the control circuit 612, as desired. This memory 614 can also be local with respect to the control circuit 612 (where, for example, both share a common circuit board, chassis, power supply, and/or housing) or can be partially or wholly remote with respect to the control circuit 612 (where, for example, the memory 614 is physically located in another facility, metropolitan area, or even country as compared to the control circuit 612).

This memory 614 can serve, for example, to non-transitorily store the computer instructions that, when executed by the control circuit 612, cause the control circuit 612 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the control circuit 612 also operably couples to a network interface 616. So configured, the control circuit 612 can communicate with other elements (both within the system 600 and external thereto) via the network interface 616. Network interfaces, including both wireless and non-wireless platforms, are well understood in the art and require no particular elaboration here. This network interface 616 can compatibly communicate via whatever network or networks 618 may be appropriate to suit the particular needs of a given application setting. Both communication networks and network interfaces are well understood areas of prior art endeavor and therefore no further elaboration will be provided here in those regards for the sake of brevity.

The system 600 further includes a shopping server 620 communicatively coupled to the control circuit 612. The shopping server 620 is configured to receive the user request 604 to view the virtual shopping environment 622, which comprises a plurality of virtual shopping images with each image including one or more virtual objects. Some examples of virtual objects may include the virtual assistant 302 (in FIG. 3), avatars 402 or 502 (in FIGS. 4 and 5), or parts of the surroundings (such as menu 306 in FIG. 3).

The control circuit 612 is configured to provide a virtual shopping experience for the user. More specifically, the control circuit 612 is configured to cause the display of virtual shopping image(s) on the user computer 602 in an interactive simulation view to emulate a real-life shopping experience for the user in which the virtual shopping images are transmitted from the shopping server 620 to the user computer 602 during the online shopping session. The control circuit 612 is further configured to manage the power demands of the system 600. More specifically, as addressed further below, it determines a real time computing resource usage of the online shopping session at different times during the online shopping session; adjusts the quality of the display of the online/virtual shopping environment 622; causes the display of virtual object(s) 624 at a first, reduced resource consumption setting to conserve computing resources when resource usage 626 is below a certain threshold; and causes the display of the virtual object(s) 624 at a second, higher resource consumption setting when resource usage 626 does not exceed this threshold. Real time computing resource usage of some or all of the virtual shopping environment 622 may be determined by one or more load analyzers, such as described above.

In one form, the adjustment of display quality 610 may be in the form of adjustment between a low resolution setting and a high resolution setting. In other words, the control circuit 612 may be configured to adjust the display of the virtual object(s) 624 between a low resolution corresponding to the first, reduced resource consumption setting and a high resolution corresponding to the second, higher resource consumption setting. In an example provided above, there may be a toggling of display quality between a high resolution or definition setting (such as, for example, 4K ultra-high definition) while in a low-load bearing situation, and a low resolution or definition setting (such as, for example, standard 720p high definition) while in a high-load bearing situation.

Alternatively, in another form, the adjustment of display quality 610 may be in the form of a sliding scale of resolution settings. The adjustment of resolution may be scalable depending on the amount of real time computing power usage. In other words, the control circuit 612 may be configured to adjust the resolution of the virtual object(s) along a range of values between a low resolution limit and a high resolution limit in response to each determination of real time computing resource usage during the online shopping session. So, in one form, instead of being limited to two resolution settings, the display quality 610 may be adjusted along a continuum of resolution settings or may be adjusted between a certain discrete number of resolution settings. For example, the display quality may be adjustable between a total of four discrete resolution settings: a low resolution, a medium resolution, a high resolution, and a very high resolution. In another example, the scaling may be adjustment of the size of the virtual object(s), such that the control circuit 612 may be configured to scale the display of the virtual object(s) between a first size corresponding to a low power usage setting and a second size corresponding to a high power usage setting.

The virtual object(s) whose display quality is adjusted may include the avatar 628, the avatar's surroundings 630, or some combination or portions thereof. In others words, in one form, the virtual object being adjusted includes an avatar 628 representing the user in the virtual shopping session, and the control circuit 612 may be configured to adjust the display of the avatar 628 or a portion of the avatar 628 between a low resolution and a high resolution. In another form, the virtual object being adjusted may represent surroundings 630 near an avatar 628, and the control circuit 612 may be configured to adjust the display of the surroundings 630 or a portion of the environment between a low resolution and a high resolution.

Further, as described above, in one optional form, the shopping server 620 may be configured to transmit a 3D virtual reality shopping environment to the user computer 602 through a virtual reality interface 606 and virtual reality system (but this is not required). For example, components of a virtual reality system may include a display device, a holographic display, an input device, audio devices, and motion sensors. The display device may present a virtual reality environment, and the user may utilize glasses to view and/or manipulate virtual products that appear to be in the user's hands. The glasses may be virtual reality glasses/goggles or augmented reality glasses/goggles. Additionally, the user may utilize haptic gloves (or other haptic devices, such as mats, sheets, objects, wearables, etc.) that simulate tactile sensations for products. In some embodiments, the holographic display may present products for the user to view and/or manipulate. Input devices may include a touchscreen, a touchpad, a keyboard, a mouse, or any other suitable input device or combination of input devices. Also, motion sensors may detect the user's movement and reorient images presented on the display device in a manner consistent with the user's movements. The motion sensors may also be used to allow the user 112 to provide input via hand gestures or may track the user's eye movements. Additionally, the virtual reality shopping station 100 may include one or more microphones to provide voice commands. This general description provides just one example of a virtual reality set-up, and it should be understood that any conventional virtual reality arrangement is suitable.

It is further contemplated that the load analysis of the system 600 may be accomplished at various times. In one form, the load analysis may be checked and rechecked at certain specific time intervals, i.e., every minute. In other words, the control circuit 612 may be configured to determine the real time computing resource usage of the online shopping session at certain time intervals and to determine whether to adjust the quality of the display at each of these time intervals. In another form, the load analysis may be checked and rechecked at different virtual shopping locations. In other words, the control circuit 612 may be configured to determine the real time computing resource usage of the online shopping session at certain online/virtual shopping locations in the virtual shopping environment 622 and to determine whether to adjust the quality of the display at each of these online/virtual shopping locations.

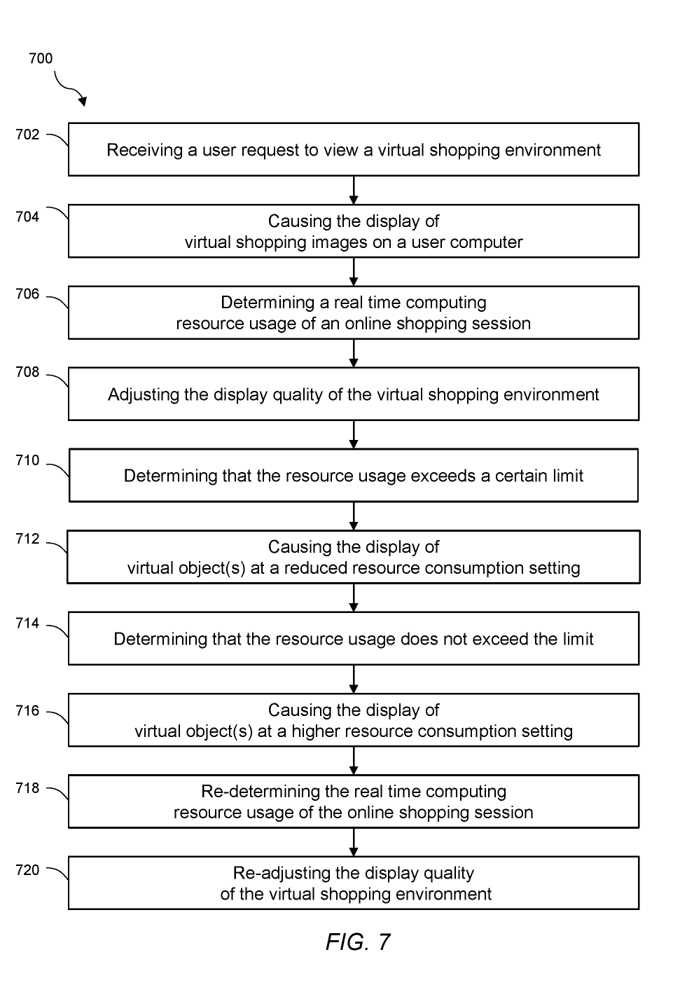

Referring to FIG. 7, there is shown a process 700 for analyzing the load of an online shopping session and providing an online shopping experience that conserves computing resources. The process 700 generally involves a request via a user computer to participate in an online shopping session, and it is contemplated that the user can interact with and browse various store departments. The process 700 further involves monitoring and adjusting display quality in order to avoid sluggish or discontinued response that may result from overwhelming resource usage demands. The process 700 may use some or all of the components described above with respect to system 600.

At block 702, a user request is received to view a virtual shopping environment. In one form, it is contemplated that the user may make this request after accessing a retailer website or software application. The user may be invited to participate in an online/virtual shopping session, and the user request may be in the form of accepting this invitation, such as by clicking on a link on the retailer website.

At block 704, the user request has been received and processed, and virtual shopping images are transmitted to and displayed on the user computer. In one form, it is generally contemplated that the virtual shopping images may include virtual objects, such as avatars (representing the customer), virtual assistants (providing shopping assistance), menus (providing navigational guidance to the user), billboards (promoting or advertising certain products), etc. It is generally contemplated that the user will be able to interact with and navigate an interactive simulation view to emulate a real-life shopping experience for the user (such as shown, for example, in FIGS. 1 and 3-5).

At block 706, a real time computing resource usage of the online shopping session is determined. This computing resource usage may involve the total of the processing and power demands of servers, computers, graphics rendering units and other units, etc. Load analyzers (such as server, CPU, GPU, and avatar load analyzers, etc.) may evaluate the power demands of various components of the virtual store backbone and/or of the various store departments. This real time computing resource usage may be compared to a certain threshold limit, and it may be desirable to maintain the resource usage below this limit (to avoid sluggish or delayed system response). At block 708, the display quality of some or all of the virtual shopping environment may be adjusted based on this comparison.

At block 710, it may be determined that the resource usage exceeds the threshold limit. This determination means that the processing and power demands on the system are too great and should be reduced. At block 712, in response, some virtual object(s) in the images may be displayed at a reduced resource consumption setting to conserve computing resources. For example, some of the virtual object(s) may be adjusted from being displayed at a relatively high resolution to being displayed at a lower resolution. This adjustment may be accomplished by switching between discrete resolution values or by moving along a continuum of resolution values. Further, in one form, the virtual object(s) whose display quality is being adjusted may include the avatar or portions of the surroundings about the avatar.

Next, at block 714, it may be determined that the resource usage does not exceed (or no longer exceeds) the threshold limit. This determination means that the processing and power demands on the system are not too great and need not be reduced. In fact, they may accommodate additional power demands, such as higher resolution or definition for some virtual object(s). At block 716, in response, some virtual object(s) in the images may be displayed at a higher resource consumption setting because it may not be necessary to conserve computing resources.

It is generally contemplated that this monitoring and comparison of the real time computing resource usage of the online shopping session is an iterative process. At block 718, the real time computing resource usage may be re-determined. It is generally contemplated that this re-determining (i.e., checking and re-checking) may be accomplished in various ways, such as at specified time intervals and/or based on the user's navigation to certain store departments. At block 720, the display quality of the virtual shopping environment may be re-adjusted. In one form, the resolution of some virtual object(s) may be increased or decreased in response to a comparison of the real time computing resource usage to a certain threshold.

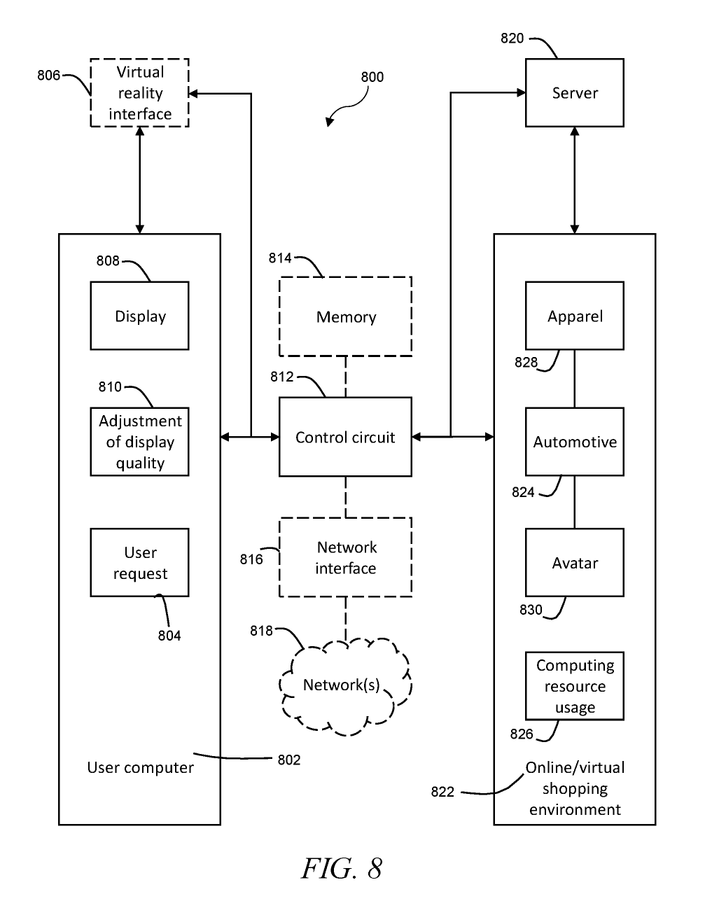

Referring to FIG. 8, there is shown a system 800 for conserving computing resources by adjusting the display quality of the avatar (representing the customer) depending on the type of product being purchased. As addressed further below, it is generally contemplated that the display quality of the avatar may be more meaningful to the customer when the customer is interacting with certain types of products. For example, a higher resolution or definition may be desirable to the customer when he or she enters the apparel department, while it is not as desirable if the customer is in the automotive department. Accordingly, as the user navigates the virtual shopping environment, the display quality of the avatar will change as the user enters certain specific store departments.

In some forms, features of each department of the online or virtual store may be exclusive to the specified department. For example, in the dressing room of an online/virtual clothing department, a customer may be able to receive visual feedback of articles of clothing worn through a virtual mirror (FIGS. 4 and 5). In contrast, this virtual mirror would not be expressed or displayed in an automotive department. Additionally, a customer's avatar expressed within the virtual or online store's backbone does not have to be as detailed as what would be employed within the virtual clothing department. Thus, a detailed customer avatar would not be displayed within the online or virtual store backbone so as to minimize resource consumption, and instead, a general avatar may be used.

Like system 600, it is generally contemplated that the user initiates an online/virtual shopping session via user computer 802. The user may initiate the session by accessing a retailer website or software application and by accepting an invitation to enter the online/virtual shopping environment. In one form, the shopping session may (but need not) involve virtual reality via a virtual reality interface 806. The user computer 802 includes a display 808, and as addressed further below, there is an adjustment of display quality 810 based on the interaction of the avatar with certain types of products and store departments.

The system 800 includes a control circuit 812 that is in communication with the user computer 802. The term “control circuit” 812 has the same general meaning, structure, and components as described above with respect to control circuit 612 of system 600. The architectural options are well known and understood in the art, and the control circuit 812 is configured to carry out one or more of the steps, actions, and/or functions described herein. Further, in one form, the control circuit 812 may be operably coupled to a memory 814 (which term has the same general meaning as memory 614 of system 600). In addition, the control circuit 812 may also be operably coupled to a network interface 816, which may, in turn, communicate via network or networks 818. Memories, communication networks, and network interfaces are well understood areas and require no further elaboration.

The system 800 further includes a shopping server 820 communicatively coupled to the control circuit 812. The shopping server 820 is generally configured to receive the user request 804 to view the online/virtual shopping environment 822 and to allow the user to navigate through the environment 822 to different store departments. This virtual shopping environment 822 generally includes a plurality of virtual shopping images, such as the images shown in FIGS. 1 and 3-5 and described above.

The control circuit 812 is configured to provide a virtual shopping experience for the user. More specifically, the control circuit 812 is configured to cause the display of virtual shopping image(s) on the user computer 802 in an interactive simulation view to emulate a real-life shopping experience for the user in which the virtual shopping images are transmitted from the shopping server 820 to the user computer 802 during the online shopping session. However, in this instance, the control circuit 812 adjusts the display quality of the avatar depending on the avatar's interaction with certain types of products. More specifically, the control circuit 812 allows the user to navigate the online/virtual shopping environment 822; displays an avatar 830 in the online/virtual shopping environment 822 (the avatar 830 representing the user or part of the body of the user); displays the avatar 830 at a first setting when the avatar 830 is interacting with certain types of products; and displays virtual shopping images at a second setting when the avatar 830 is not interacting with these products.

FIG. 8 show two products that may result in the avatar 830 or virtual shopping images being displayed at different settings. The first type of product is apparel 828. It may be desirable to display the avatar 830 at a high display quality (such as at a high resolution or definition) so that the user can perceive how the apparel (pants, shirts, etc.) appears on the avatar 830. As described above, with reference to FIGS. 4 and 5, it is expected that a customer may prefer a high resolution or definition when he or she interacts with certain types of products that may be worn on, or that may adorn, the user's body (such as, for example, apparel, shoes, watches, jewelry, cosmetics, etc.). These types of products generally require a more subjective judgment from the customer, so a high resolution or definition may provide the best feedback as to the appearance of the product (without the user actually being in the store to experience the product). In one form, it is contemplated that the customer may input measurements of the customer or may input a body scan to provide realistic and accurate information for the display of the avatar 830 with the product. In this context, it may make sense to allow for relatively high computer resource usage 826.

The second type of product in this example is an automotive product 824. In this form, there may not be a significant amount of interaction between the avatar 830 and the product. For example, the customer may not be too concerned with how the customer appears relative to tires, windshield wipers, or other automotive products. There may simply be no subjective judgment by the customer relating to appearance. In this context, it may make sense to display the avatar 830 at a low resolution or definition in order to conserve computing resources. In another form, the avatar may not be displayed at all in the automotive department, and the automotive department and its products may be displayed at a low resolution to conserve computing resources. Further, it may make sense to maintain this low resolution or definition when the avatar 830 is in a general area of the shopping environment (such as, for example, in the online/virtual store backbone shown in FIGS. 1 and 3). Again, in one form, the avatar 830 need not even be displayed in this general area (see FIG. 3).

In other words, in one form, the avatar 830 may be displayed at a low resolution at general shopping areas and non-interactive departments. The virtual shopping images may include images of general shopping areas and images of virtual store department locations corresponding to non-interactive products, i.e., any products that are not to be included in the first group warranting a high quality display. The avatar 830 may be displayed in the low display quality setting when the control circuit 812 navigates to general shopping areas or to virtual store department locations corresponding to the non-interactive products. Alternatively, in another form, the avatar 830 may not be displayed in any of these locations or may be displayed in only some of these locations, e.g., general shopping areas or virtual store departments corresponding to non-interactive products

In one form, the system 800 may use a number of different display quality settings depending on the specific type of product. For example, the control circuit 812 may be configured to adjust the display setting of the avatar 830 between the following products in descending order: clothing (highest resolution setting), cosmetics (second highest resolution setting), jewelry and watches (intermediate resolution setting), and all other products (lowest resolution setting). Further, in one form, the display quality of the avatar 830 may be adjusted as the avatar 830 is entering specific online/virtual store department locations corresponding to the types of products for which a higher display quality is desirable. In other words, the control circuit 812 may be configured to adjust the display quality of the avatar 830 to the first resource consumption setting at certain specific online/virtual store department locations in the online/virtual shopping environment 822 (where each online/virtual store department location corresponds to a product for which a higher display quality is preferred).

In addition, it is contemplated that the high display quality need not be limited to the avatar 830 but may also include some or all of the corresponding interacting product or store department. For example, in one form, the control circuit 812 may be configured to display an interacting product at a high resolution or definition when the avatar 830 is actually interacting with the product. In considering the interacting product, it is generally contemplated that the customer will desire to see the appearance of both the avatar 830 and the interacting product as clearly as reasonably possible. For example, a customer having an avatar 830 wear a dress will prefer a high resolution in order to determine the appearance of both the avatar 830 and the dress.

Moreover, in one aspect, it is contemplated that this approach may also reduce the returns and exchanges associated with products worn by customers. Essentially, customers will be able to try on certain products within the online and virtual shopping experience, which is intended to provide accurate feedback to the customer as to how the product will fit the individual's specific size and shape, without requiring that the customer expend the effort of physically trying on the clothing. The data for the customer's size specifications may be achieved through data inputs inputted by the customer directly or by body scanners. This approach may provide the most accurate feedback as to how a product will look and feel without requiring the customer to actually interact with the product in a physical environment. Instead, the customer's virtual avatar may simulate the physical feedback the customer would receive in a physical environment.

Further, in one form, it is contemplated that the system 800 may also take into account the real time load on the server 820 and other computer/processing units from the departments and may adjust the display quality of the departments accordingly. In other words, the system 800 may take into account the overall demand on the system 800 and reduce or discontinue the high display quality at those store departments. For example, in one form, the control circuit 812 may be configured to: determine the total real time computing resource usage of the server 820 during the online shopping session at certain virtual store department locations and reduce the display quality at one or more of these virtual store department locations when the total real time computing resource usage exceeds a certain limit. In addition, the control circuit 812 may determine the minimum amount of reduction in display quality that may be required at these virtual store department locations. For example, the control circuit 812 may be configured to: calculate the computing resource usage required at each virtual store department location to maintain the total real time computing resource usage at the limit (or threshold) and adjust the display quality at each virtual store department location to maintain the total real time computing resource usage at the limit.

The system 800 may allow for the input of body dimensions in several different ways. These body dimensions may be used to more accurately show the avatar's interaction with certain types of products. In one form, the system 800 may include an input device that is communicatively coupled to the server 820 such that the input device allows a user to input dimensions of the user's body or portions of the user's body. Some examples of such input devices include a 3D body scanner, an image capture device (such as a camera or other video equipment), and a keyboard (for manually inputting dimensions and sizes).

In addition, the system 800 may allow a user to choose a background when trying on interactive products. For example, as shown in FIG. 5, the system 800 may include a number of different predefined background templates to allow the user to see the product in different environments and circumstances. In other words, the control circuit 812 may be configured to display the avatar 830 interacting with the product in several predetermined background settings, and this display may be at a high resolution or definition.

In summary, in one form, this system 800 relates to a retail store system that allows a customer to create and navigate in an online/virtual store and that conserves computing power in this environment. The system 800 could use low resolution and still images for most graphics and navigation through the virtual store. The system 800 could use high resolution and otherwise use significant computing power when required for interaction by the customer. For example, when the customer tries on apparel, shoes, or jewelry/watches, the system 800 can scan or input the customer's specific dimensions and characteristics in order to try on these items. The system 800 may convert between low computing power (such as for a smaller data representation avatar and simple navigation through the store) and high computing power (such as for a model/avatar of the customer who enters a dressing room to try on clothes).

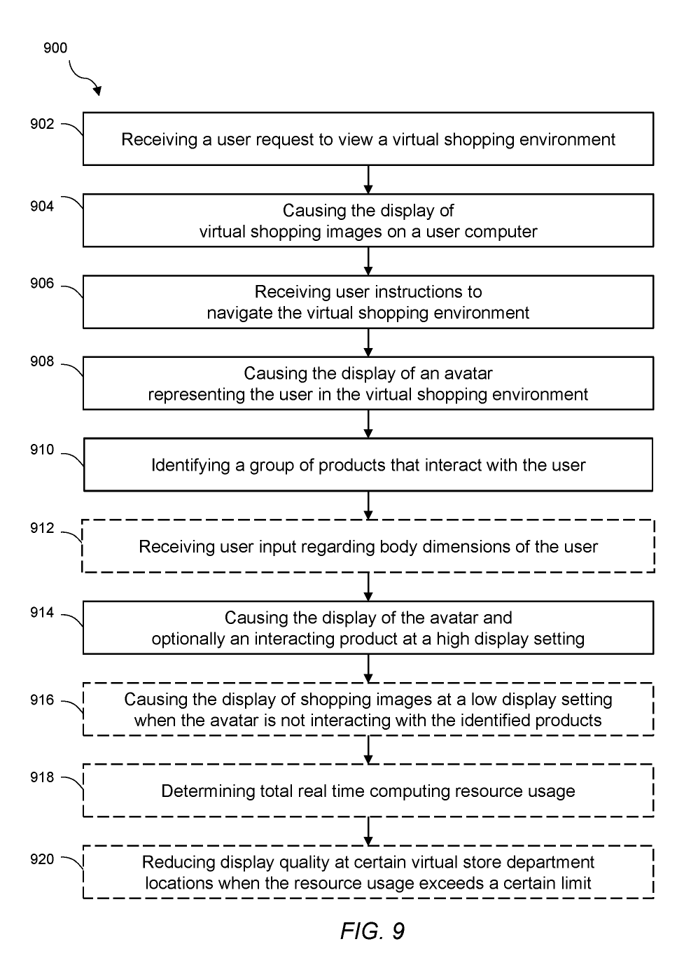

Referring to FIG. 9, there is shown a process 900 for conserving computing resources by adjusting the display of an avatar representing the user depending on the product being purchased. The process 900 is generally intended to display the avatar in a high quality display setting, i.e., at a high resolution, when the avatar is interacting with a product where the appearance of the avatar interacting with the product is meaningful. In other circumstances, the avatar is intended for display in a low quality display setting, i.e., at a low resolution, in order to conserve computing resources. In these other circumstances, the exact appearance of the avatar is not significant enough to warrant the use of additional computing resources. Alternatively, the avatar 830 need not be displayed at all when not interacting with products, and in this instance, the virtual shopping images may be displayed at a relatively low resolution to conserve computing resources. The process 900 may use some or all of the components described above in connection with system 800.

At block 902, a user request is received to view a virtual shopping environment. The user may make such a request, for example, after accessing a retailer website or software application. In one form, the user may click on a link on a retailer website to, in effect, make this request. At block 904, the user request has been received, and the user has been permitted to access the online/virtual shopping environment. Virtual shopping images are transmitted to and displayed on the user's computer, and examples of such images are shown at FIGS. 1 and 3-5.

At block 906, user instructions are received for navigating the virtual shopping environment. In one form, it is generally contemplated that the virtual shopping images transmitted to the user's computer may include, without limitation, an avatar, a virtual assistant who can answer the user's questions, menus that can assist the user with navigating through the online/virtual shopping environment, and various store departments where various types of products are sold. For example, as described above with respect to system 800, menus or signs may direct the user to an apparel department, an automotive department, and other departments. It is generally contemplated that the user will be able to interact with and navigate through an interactive simulation view to emulate a real-life shopping experience.

At block 908, an avatar representing the user is caused to be displayed in the online/virtual shopping environment. In one form, it is contemplated that the avatar may navigate and may be displayed in the various stores in the online/virtual shopping environment as the avatar moves between the stores. In another form, it is contemplated that the avatar may only be displayed when he or she is interacting with a certain group of products, such as, for example, apparel, shoes, watches, jewelry, cosmetics, etc., and may not be displayed otherwise. In other words, the avatar may be display at a higher resolution than the display of virtual shopping images otherwise when the avatar is interacting with the certain group of products.

At block 910, the products in this group of products that interact with the user are identified. It is generally contemplated that this group of products is identified and selected prior to the user's initiation of the online/virtual shopping session. It should be evident that the order of sequence of steps shown in FIG. 9 is not required and that some steps may be performed before or after other steps shown in FIG. 9.

At block 912, user input of the body dimensions of the user may be received. It is generally contemplated that this user input may be provided in various ways, such as through the use of a body scanner, the use of a camera or other image capture device, or by manual keyboard entry of size or dimension measurements. In one form, it is contemplated that this body dimension input may be provided when the user first enters a store department (such as a clothing department) where these body dimensions may become relevant. Once these user body dimensions are inputted, they may be stored in a memory for future use (subject to modification by the user).

At block 914, the avatar (and optionally an interacting product) are caused to be displayed at a high display setting, such as at a high resolution or definition. In one form, it is generally contemplated that the user has navigated to a store department (such as a clothing department) that offers a product that has been identified as belonging to the group of interacting products. When the user is in the store department, the user may select one or more items (such as pants, shirts, dresses, etc.) with which they desire to interact, i.e., the user wants the avatar to try on some of the clothes to see how they look on the avatar. For example, as described above in conjunction with FIGS. 4 and 5, the process may use a virtual mirror 404 to allow the user to indicate that he or she wants to see the avatar wearing one or more selected clothing items. Further, as shown in FIG. 5, the user may be prompted to select a background template in which the avatar is wearing the selected clothing items. In this context, the avatar and optionally the clothing items may be shown in high resolution so that the user can perceive the appearance in sharp detail. In another form, only a portion of the avatar may be shown in high resolution (such as an arm trying on a watch or jewelry).

At block 916, after the avatar has finished interacting with the product (such as clothing items), the avatar may be caused to be displayed at a relatively low display quality setting, i.e., at a low resolution. For example, the avatar 402 shown in FIG. 4 may be displayed at a lower resolution than the avatar 502 shown in FIG. 5. In FIG. 4, the avatar 402 is not interacting with the product (clothes), while in FIG. 5, the avatar is interacting with the product. By displaying the avatar and products at a low resolution setting when they are not actually interacting with one another, the process 900 does not unnecessarily waste computing resources. Alternatively, the avatar need not be displayed when not interacting with products, and in this circumstance, the virtual shopping images may be displayed at a relatively low resolution.

Optionally, at blocks 918 and 920, the total computing resource usage is monitored to seek to avoid overuse and a sluggish or delayed response of the process 900. At block 918, the total real time computing resource usage is determined. For example, this computing resource usage may involve the total of the processing and power demands of servers, computers, graphics rendering units and other units, etc., and load analyzers for each processing component may be used to evaluate the power demands. This real time computing resource usage may be compared to a certain upper threshold of resource usage.

At block 920, the display quality may be reduced at certain online/virtual store department locations when the resource usage exceeds the upper threshold. It is generally contemplated that, during ordinary operation, the avatar and optionally certain products (such as clothes) may be shown at a high display quality setting in certain store departments. However, if the total computing resource usage is too high, i.e., exceeds the upper threshold, the process 900 will no longer operate in the ordinary manner. Instead, it may be determined that one or more of the store departments with this high display quality will no longer operate in that manner until the total computing resource usage falls to a normal level below the upper threshold. The one or more store departments may only provide low display quality operation until the total computing resource usage is again within the desired range. In an optional form, at block 920, the process 900 may include reducing the display quality at each virtual store department location to maintain the total real time computing resource usage at or around the upper threshold.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing an online shopping experience that conserves computing resources, the system comprising:
a shopping server configured to receive a user request to view a virtual shopping environment comprising a plurality of virtual shopping images, each image including one or more virtual objects;
a control circuit configured to:
cause the display of at least one of the plurality of virtual shopping images on a user computer in an interactive simulation view to emulate a real-life shopping experience for the user, the virtual shopping images being transmitted from the shopping server to the user computer during an online shopping session;
determine a real time computing resource usage of the online shopping session at different times during the online shopping session;
adjust a quality of the display of the virtual shopping environment;
cause the display of at least one of the virtual objects at a first, reduced resource consumption setting to conserve computing resources in response to a determination that the resource usage exceeds a predetermined limit; and
cause the display of the at least one virtual object at a second, higher resource consumption setting in response to a determination that the resource usage does not exceed the predetermined limit.

2. The system of claim 1, wherein:
the control circuit is configured to adjust the display of the at least one virtual object between a low resolution corresponding to the first, reduced resource consumption setting and a high resolution corresponding to the second, higher resource consumption setting.

3. The system of claim 2, wherein:
the control circuit is configured to adjust the resolution of the at least one virtual object along a range of values between a low resolution limit and a high resolution limit in response to each determination of real time computing resource usage during the online shopping session.

4. The system of claim 1, wherein:
the at least one virtual object comprises an avatar representing the user in the virtual shopping session; and
the control circuit is configured to adjust the display of the avatar or a portion of the avatar between a low resolution and a high resolution.

5. The system of claim 1, wherein:
the at least one virtual object represents the surroundings near an avatar that represents the user in the virtual shopping session; and
the control circuit is configured to adjust the display of the surroundings or a portion of the environment between a low resolution and a high resolution.

6. The system of claim 1, wherein:
the control circuit is configured to scale the display of the at least one virtual object between a first size corresponding to the first, reduced resource consumption setting and a second size corresponding to the second, higher resource consumption setting.

7. The system of claim 1, wherein the user computer comprises a desktop computer, laptop computer, tablet computer, or mobile computing device.

8. The system of claim 1, wherein the control circuit is configured to:
determine the real time computing resource usage of the online shopping session at predetermined time intervals; and
determine whether to adjust the quality of the display of the virtual shopping environment at each of these predetermined time intervals.

9. The system of claim 1, wherein the control circuit is configured to:
determine the real time computing resource usage of the online shopping session at predetermined virtual shopping locations in the virtual shopping environment; and
determine whether to adjust the quality of the display of the virtual shopping environment at each of these predetermined virtual shopping locations.

10. The system of claim 1, wherein the control circuit is configured to determine the real time computing resource usage of at least one of the shopping server and the user computer.

11. The system of claim 1, wherein the shopping server is configured to transmit a 3D virtual reality shopping environment to the user computer through a virtual reality interface.

12. A method for providing an online shopping experience that conserves computing resources, the method comprising:
by a shopping server, receiving a user request to view a virtual shopping environment comprising a plurality of virtual shopping images, each image including one or more virtual objects;
by a control circuit:
causing to display at least one of the plurality of virtual shopping images on a user computer in an interactive simulation view to emulate a real-life shopping experience for the user, the virtual shopping images being transmitted from the shopping server to the user computer during an online shopping session;
determining a real time computing resource usage of the online shopping session at different times during the online shopping session;
adjusting a quality of the display of the virtual shopping environment;
causing to display at least one of the virtual objects at a first, reduced resource consumption setting to conserve computing resources in response to a determination that the resource usage exceed a predetermined limit; and
causing to display the at least one virtual object at a second, higher resource consumption setting in response to a determination that the resource usage does not exceed the predetermined limit.

13. The method of claim 12, further comprising, by the control circuit:
adjusting the display of the at least one virtual object between a low resolution corresponding to the first, reduced resource consumption setting and a high resolution corresponding to the second, higher resource consumption setting.

14. The method of claim 13, further comprising, by the control circuit:
adjusting the resolution of the at least one virtual object along a range of values between a low resolution limit and a high resolution limit in response to each determination of real time computing resource usage during the online shopping session.

15. The method of claim 12:
wherein the at least one virtual object comprises an avatar representing the user in the virtual shopping session; and
further comprising, by the control circuit, adjusting the display of the avatar or a portion of the avatar between a low resolution and a high resolution.

16. The method of claim 12:
wherein the at least one virtual object represents the surroundings near an avatar that represents the user in the virtual shopping session; and
further comprising, by the control circuit, adjusting the display of the surroundings or a portion of the environment between a low resolution and a high resolution.

17. The method of claim 12, further comprising, by the control circuit:
scaling the display of the at least one virtual object between a first size corresponding to the first, reduced resource consumption setting and a second size corresponding to the second, higher resource consumption setting.

18. The method of claim 12, further comprising, by the control circuit:
determining the real time computing resource usage of the online shopping session at predetermined time intervals; and
determining whether to adjust the quality of the display of the virtual shopping environment at each of these predetermined time intervals.

19. The method of claim 12, further comprising, by the control circuit:
determining the real time computing resource usage of the online shopping session at predetermined virtual shopping locations in the virtual shopping environment; and
determining whether to adjust the quality of the display of the virtual shopping environment at each of these predetermined virtual shopping locations.

20. The method of claim 12, further comprising, by the control circuit, determining the real time computing resource usage of at least one of the shopping server and the user computer.
